(19) United States
(12) Patent Application Publication
(10) Pub. No.: US 2004/0125594 A1
(43) Pub. Date: Jul. 1, 2004

(54) Coaster Structure

(76) Inventor: Pei-Cheng Wu, Junghe City (TW)

Correspondence Address: YAO-HSING CO., LTD, P.O. Box No. 6-57, Chung-Ho, Taipei, 235, TW

(21) Appl. No.: 10/330,237

(22) Filed: Dec. 30, 2002

(51) Int. Cl. F21V 33/00

(52) U.S. Cl. 362/101; 362/276; 362/806

(57) ABSTRACT

A coaster of the present invention is provided with a platform, which has two circular top slots bridged by a bottom slot, two contact sections implemented inside the top slots and the bottom slot, two button batteries positioned inside the two top slots respectively, an elastic plate on the upper surface of the batteries, and a LED is placed into the center of the elastic plate; the platform is mounted to a transparent top lid construct a coaster. When the weight of a cup or a heavy arcticle placed on the coaster thereby pressing the top lid downwardly towards against the elastic plate correspondingly followed by two pins protruded out of the LED configuring contacts with the two contact sections respectively enables the LED being illuminated with a lighting effect on the coaster.

### BACKGROUND OF THE INVENTION

1. Field of the Invention

The present invention relates to a coaster structure, more particularly to a coaster structure having an illuminated effect when a cup is placed thereon.

2. Description of the Prior Art

Generally, coasters are widely used to prevent the beverage steam within a cup getting dirty from a table or table cloth. The coasters set apart of the cup and the table. The coasters of the prior art are made of simple fabrics, plastic, or other plate-form material bearing graphics without other functions of adding interest or appealing.

### SUMMARY OF THE INVENTION

The primary objective of the present invention is to provide a coaster structure which increases a practical function having a lighting effect while the weight of a cup is placed on the coaster.

The coaster structure is comprised of a platform and a top lid; wherein, a platform has two circular top slots bridged by a bottom slot, two contact sections are provided inside the two top slots and the bottom slot, two button batteries are positioned inside the two top slots respectively, an elastic plate is placed on the upper surface of the batteries, and a LED is disposed on the center of the elastic plate; a top lid is made of a soft material having a connective slot on the center thereby accommondating the LED and thus constructing an illuminated coaster when a cup or a heavy arcticle is positioned on the coaster, the weight thereon pressing the top lid, and downwardly toward against the elastic plate, followed by two pins protruded out of the LED are configured to contact the two contact sections respectively enables the LED being illuminated with a lighting effect within the perimeter of the cup.

To enable a further understanding of the said objectives as well as other objectives, and structure details of the invention herein, the detailed description of the invention applications along with the brief description of drawings below shall provide additional elaboration.

### BRIEF DESCRIPTION OF THE DRAWINGS

FIG. 1 is a perspective exploded view of the present invention.

FIG. 2 is a perspective view of the present invention.

FIG. 3 is a cross-sectional view of the present invention.

FIG. 4 is a perspective view of a preferred embodiment of the present invention.

FIG. 5 is a perspective view illustrating the LED light-on of the present invention.

### DESCRIPTION OF THE PREFERRED EMBODIMENTS

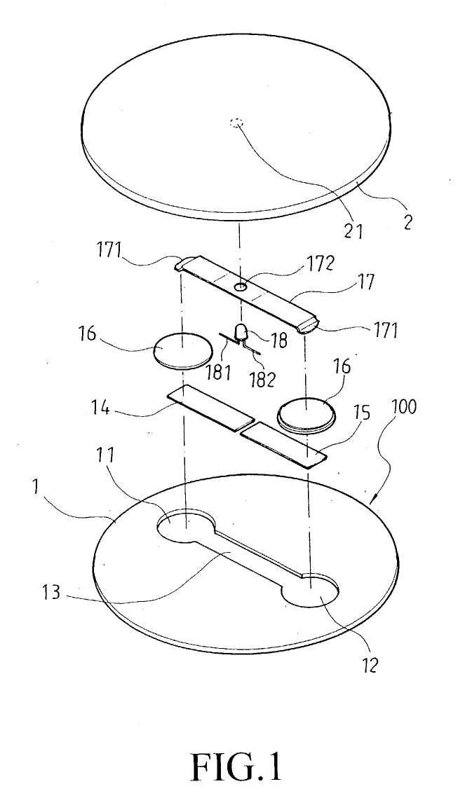

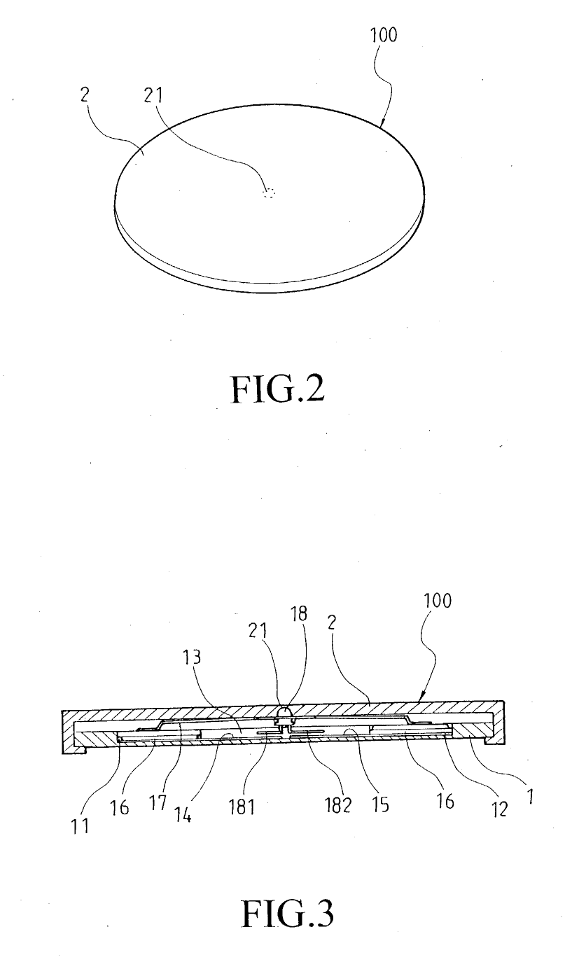

Referring to FIG. 1, FIG. 2 and FIG. 3, a perspective view, a perspective exploded view and a cross-sectional view of the present invention herein, a coaster 100 of the present invention consists essentially of a platform 1 and a top lid 2. The platform 1 is a planar section which comprises two circular top slots 11 and 12, and both circular top slots are connected by a bottom slot 13. Two contact sections 14 and 15 are implemented inside the two top slots 11 and 12; two button batteries 16 are positioned inside the top slots 11 and 12. A elastic plate 17 is placed on the upper surface of the batteries; wherein, two folding sections 171 are formed on two ends of the elastic plate 17 to enable appropriate elasticity. The center of the elastic plate 17 has an air vent 172 which enables the LED 18 being disposed into the air vent 172 from downwardly to upwardly.

The top lid 2 is a semi-transparent and soft material, which has a connective slot 21 forming on the center thereof; the connective slot 21 is disposed in upright positions corresponds to the platform 1 thereby constructing a coaster 100. Furthermore, when the top lid 2 is mounted to the platform 1, the folding sections 171, located respectively on the two ends of the elastic plate 17 is correspondingly placed against to an anode and a dectrode of a button battery 16 enabling the elastic plate 17 is electrically connected with the batteries 16. Accordingly, when a cup is set on the coaster 100, two pins 181 and 182 of the LED are configured respectively in contact with the two contact sections 14 and 15 by the weight of the cup. Thus, the LED is illuminated and, through the top lid 2, the light emits toward the outer circumferential area to create a lighting effect.

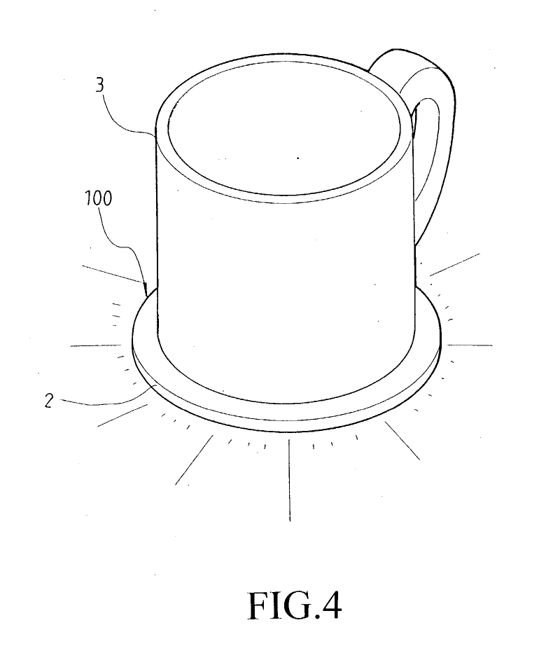

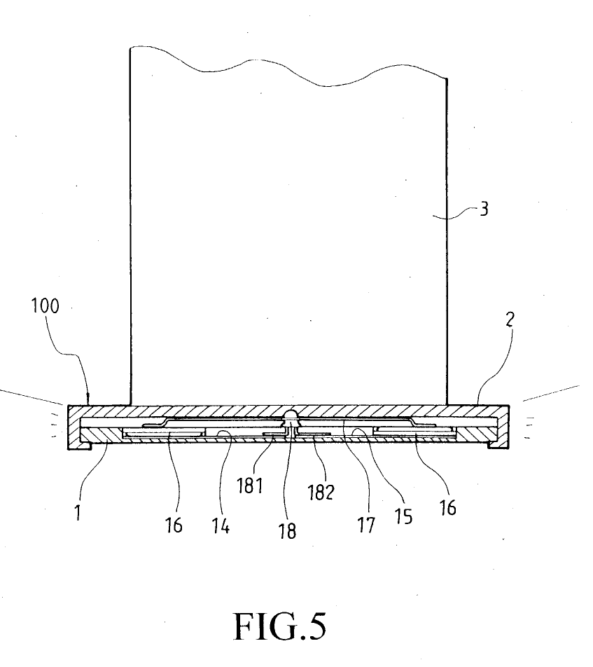

Referring to FIG. 4 and FIG. 5, a perspective view of a preferred embodiment showing a LED of this invention, when the cup 3 is placed on the coaster 100 the weight thereby pressing the soft-material top lid 2 downwardly towards against the elastic plate 17 enabling two pins 181 and 182 of the LED 18 are in contact with the two contact sections 14 and 15 followed by electrically engaging the batteries 16 to illuminate the LED 18. The light emits from the LED 18 through the top lids 2 and towards the outer circumferential area of the coaster 100 with a lighting effect.

In summation of the foregoing sections, the present invention is explained with a practical assembly. It is of course to be understood that the embodiment described herein are merely illustrative of the principles of the invention and that a wide variety of modifications thereto may be effected by persons skilled in the art without departing from the spirit and scope of the invention as set forth in the following claims.

1. A coaster structure comprising:
a platform having two circular top slots bridged by a bottom slot, wherein two contact sections are provided inside the two top slots and the bottom slot, and two button batteries positioned inside the two top slots respectively; an elastic plate is disposed on an upper surface of the batteries, and a LED is disposed to the center of the elastic plate; a top lid is made of a soft material with a connective slot within the center thereby accomondating the LED; by constructing above said components, a cup or a heavy arcticle placed on the coaster thereby pressing the top lid downwardly towards against the elstic plate followed by two pins protruded out of the LED which are configured to contact the two contact sections respectively, enabling the LED being illuminated with a lighting effect.

2. The coaster structure in accordance with claim 1, wherein, two folding sections formed on two ends of the elastic plate is positioned on the upper surface of the batteries, wherein, two folding sections being formed to enable appropriate elasticity with the elastic plate.
